(19) United States
(12) Patent Application Publication
(10) Pub. No.: US 2014/0072854 A1
(43) Pub. Date: Mar. 13, 2014

(54) Energy Storage Module and Fixing Assembly for the Energy Storage Module

(71) Applicant: Bayerische Motoren Werke Aktiengesellschaft, Muenchen (DE)

(72) Inventor: Hubertus GOESMANN, Nattheim-Auernheim (DE)

(73) Assignee: Bayerische Motoren Werke Aktiengesellschaft, Muenchen (DE)

(21) Appl. No.: 14/079,781

(22) Filed: Nov. 14, 2013

Related U.S. Application Data
(63) Continuation of application No. PCT/EP2012/002431, filed on Jun. 8, 2012.

(30) Foreign Application Priority Data
Jul. 12, 2011 (DE) 10 2011 078 983.9

(51) Int. Cl. H01M 2/10

(52) U.S. Cl. CPC H01M 2/1083
USPC 429/99; 429/100

(57) ABSTRACT

An energy storage module for a device, particularly of a motor vehicle, is provided. energy storage module includes multiple storage cells which are tensioned between end plates via tie anchors and being designed to be placed on and locked on at least one fixed locking bracket. Preferably at least one of the two end plates has a locking element which is connected to the end plate in a pivoting and/or sliding manner, and the locking element can be locked to the locking bracket by a pivoting and/or locking movement of the locking element.

### CROSS REFERENCE TO RELATED APPLICATIONS

This application is a continuation of PCT International Application No. PCT/EP2012/002431, filed Jun. 8, 2012, which claims priority under 35 U.S.C. §119 from German Patent Application No. DE 10 2011 078 983.9, filed Jul. 12, 2011, the entire disclosures of which are expressly incorporated by reference herein.

### BACKGROUND AND SUMMARY OF THE INVENTION

The invention relates to an energy storage module for a device, particularly of a motor vehicle, for supplying voltage, said energy storage module consisting of multiple storage cells which are braced between two end plates via tie anchors. The invention also relates to an attachment arrangement for the energy storage module.

In a device for supplying a motor vehicle with voltage, typically termed a battery, usually a plurality of energy storage modules are used to drive the vehicle, for example an electric vehicle or hybrid vehicle. Each energy storage module typically consists of multiple stacked, prismatic storage cells. The individual storage cells contain electrochemical cells of the battery. The stack consisting of the individual storage cells is typically braced to the energy storage module via a mechanical end plate and tie anchor. In addition to mechanically fixing the modules to each other, the end plates and tie anchors particularly serve the purpose of countering a deformation resulting from changes in gas pressure, the same occurring during operation in the electrochemical cells arranged in the interior of the modules.

The energy storage modules are mounted in the device for supplying voltage, and particularly in motor vehicles. This typically takes place by an attachment device, for example a bolt. For the purpose of connecting the bolt and the energy storage module, extensions have been included on the energy storage module up until now. The attachment device is inserted through these extensions, and can therefore be mounted in the motor vehicle, for example. These extensions project beyond the energy storage module, and therefore increase the constructed space of the energy storage module in an inconvenient manner. In addition, this attachment method using bolts and nuts is time-consuming during the assembly. FIG. 7 shows a threaded connection—not according to the invention—of an energy storage module. As illustrated, an extension 106 projects past the end plate 30 in this conventional method. A bolt 101 is inserted into the extension 106 as an attachment device. This bolt 101 is fixed by the threaded connection 105.

The problem addressed by the present invention is that of providing an energy storage module for a device which supplies voltage, wherein said energy storage module can be produced in a simple manner, and can be securely attached while having the least possible constructed space. In addition, the invention addresses the problem of providing a corresponding attachment arrangement for the energy storage module.

As such, the problem is addressed by an energy storage module for a device which supplies voltage, particularly of a motor vehicle, consisting of multiple storage cells which are braced between two end plates via tie anchors, wherein the energy storage module is designed to be placed on and locked on at least one fixed locking bracket, wherein at least one of the two end plates has a locking element connected to the end plate in a pivoting and/or sliding manner, and wherein the locking element can be locked to the locking bracket by a pivoting and/or sliding movement of the locking element.

Thanks to the locking element according to the invention, the energy storage module can be fixed, for example in a vehicle body, in a very simple manner. The locking brackets preferably project vertically out of the body. The energy storage modules can therefore be placed on the locking brackets from above. With only one hand movement, the locking elements are pivoted and/or slid, thereby creating a force-fit and/or positive-fitting connection between the end plates and the locking brackets. In a preferred embodiment, one locking element is included on each of the two end plates. Accordingly, in this case there is one locking bracket for each end plate. By dispensing with the threaded connection, the complexity of assembly is reduced significantly.

In one advantageous embodiment, the locking element has a clamping surface. The clamping surface is particularly arranged in such a manner that it clamps under a locking extension on the locking bracket after the pivoting or sliding. This locking extension is particularly designed as a locking bolt. This clamping under the locking extension particularly enables a self-locking and/or zero-play locking.

In addition, a spring is advantageously arranged between the locking element and the end plate. The spring loads the locking element in the direction of the locking movement. The locking element is particularly arranged in such a manner that the locking element snaps down by the spring force after the energy storage module is placed on the locking bracket. In this case, particularly a tension spring is used.

Moreover, the end plate advantageously has at least one recess for the insertion of the locking bracket. As a result of this recess, a positive-fitting connection between the locking bracket and the energy storage module and/or end plate is created. In particular, the recess or the multiple recesses is/are designed as through borings. The locking bracket which sits in the through boring prevents a sliding of the energy storage module in every direction perpendicular to the locking bracket. In particular, one recess, and particularly a through boring, is included on each of the upper and lower ends of the end plate.

In one particularly preferred embodiment, the end plate is designed with a double wall. The locking element in this case is situated between the two walls. When assembled, the attachment bracket also preferably extends at least partially between the two walls. In particular, the recess and/or the through boring leads from the outside into an intermediate space between the two walls. As an alternative, the end plate is designed as a cast aluminum component.

In addition, the locking element is preferably designed as an eccentric. In a particularly preferred configuration, the eccentric is connected to the end plate in a rotating manner via a pivot axle. The pivot axle is preferably arranged parallel to the tension direction of the tie anchor. In a configuration wherein the tension spring described above is used, the tension spring engages with the eccentric on one side of the pivot axle. The clamping surface is constructed on the other side of the pivot axle on the eccentric. In this way, among other things, it is possible to achieve a self-locking configuration of the clamping.

The invention also includes an attachment arrangement having at least one of the energy storage modules described above, and at least one locking bracket on which the energy storage module is placed. The advantageous embodiments described in the context of the energy storage module according to the invention are also advantageously applied to the attachment arrangement according to the invention.

In particular, the locking bracket is fixed on one end to a device, particularly a housing or a vehicle body. The locking element in this case is arranged in such a manner that the clamping surface of the locking element engages underneath a surface of the locking bracket, said surface facing the fixed end. In particular, the side of a locking extension or a locking bolt which is functionally assigned to the fixed end of the locking bracket is the side which engages underneath the clamping surface. When installed, preferably the underside of the energy storage module sits on the housing or the vehicle body. In this way, further movement of the energy storage module downward is blocked. The clamping surface, in cooperation with the locking bracket, particularly the locking extension, prevents the energy storage module from being lifted in a direction parallel to the locking bracket. In addition, by this arrangement of the clamping surface, a self-locking and zero-play locking is possible. The locking extension and/or the locking bolt preferably extend(s) perpendicular to the locking bracket and/or parallel to the horizontal.

Moreover, the locking element and the locking bracket, particularly the locking extension, preferably are designed for a self-locking clamping. The self-locking clamping is supported, on the first hand, by the fact that the clamping surface engages underneath the surface of the locking extension which faces the fixed end of the locking bracket. On the other hand, the self-locking function is realized, in the case of an eccentric, by the geometric construction of the clamping surface, and by the arrangement of the pivot axle of the eccentric.

Moreover, the locking bracket is advantageously designed for multiple energy storage modules, stacked on top of each other, to be placed thereon. For this purpose, the locking bracket is designed as longer than a height of one energy storage module. In addition, the locking bracket preferably has multiple locking extensions arranged on top of each other for this purpose. An intermediate base can preferably be placed on the locking bracket between the energy storage modules stacked on top of each other. The intermediate bases then likewise have, similar to the end plates, recesses or through borings into which the locking brackets are inserted.

The locking bracket is particularly designed as a straight rod and/or plate, or has two parallel plates which are spaced apart from each other.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows storage cells of the energy storage module according to an embodiment of the invention,

FIG. 2 shows the energy storage module equipped with storage cells according to an embodiment of the invention,

FIG. 3 shows a detailed view of the attachment arrangement according to another embodiment of the invention,

FIG. 4 shows a detailed view of the attachment arrangement according to a further embodiment of the invention,

FIG. 5 shows a detailed view of the attachment arrangement according to another embodiment of the invention,

FIG. 6 shows a detailed view of the attachment arrangement according to an additional embodiment of the invention, and

FIG. 7 shows a conventional threaded connection of an energy storage module, not according to the invention.

### DETAILED DESCRIPTION OF THE DRAWINGS

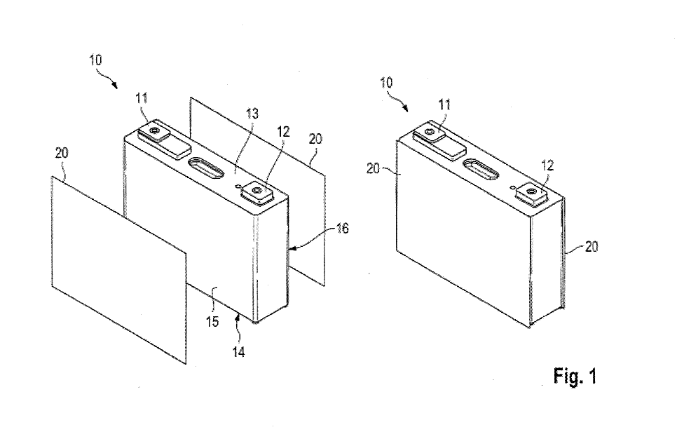

FIG. 1 shows a single, prismatic storage cell 10 of an energy storage module 1, the same described in its entirety below, in a perspective view. The storage cell 10 typically consists of one or multiple individual electrochemical cells—which are hidden in the interior of the storage cell 10 in the illustration selected here. The storage cell 10 has, on a front side 13 thereof, a connection terminal 11 with a first polarity, and a connection terminal 12 with a second polarity. On the rear side 14 of the storage cell 10, which is not illustrated in the figure, no connection terminals are included. One of the connection terminals 11, 12, typically the plus pole of the storage cell, can be electrically connected to a housing of the storage cell 10. Because multiple storage cells 10 can be stacked behind each other, at least in a series, in the energy storage module 1 according to the invention, at least the primary surfaces 15, 16 are configured with an electrically insulating material. In the embodiment illustrated in FIG. 1, an adhesive film 20 is attached to the primary surfaces 15, 16.

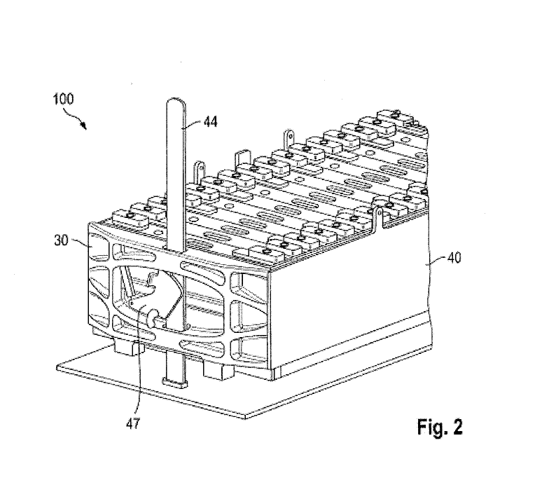

In the energy storage module according to the invention, according to FIG. 2, the storage cells 10 are arranged in a row of storage cells, by way of example. The tensioning of the storage cell stacked in a row is realized by using end plates 30 and tie anchors 40, 42. A second end plate, which is not illustrated, is located opposite the illustrated end plate 30. The end plates are also characterized as pressure plates.

In FIG. 2, the end plates according to the first embodiment are designed as cast aluminum plates. A locking element 47 is included inside the end plate 30. To attach the energy storage module 1, the same is placed on the locking bracket 44. The locking element 47 then works together with the locking bracket 44 to attach the energy storage module 1. The precise establishment of the locking is described in greater detail in the following figures.

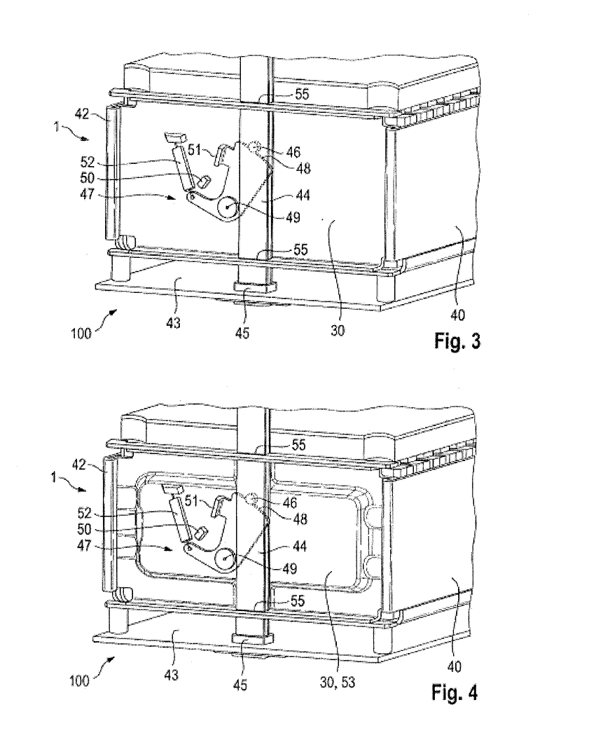

A second embodiment of an attachment arrangement 100 according to the invention is described with reference to FIG. 3. Identical and/or functionally identical components are indicated by the same reference numbers in all embodiments. The figure shows the end plate 30 as a stamped, curved part of the energy storage module 1, as well as two tie anchors 40, 42. The energy storage module 1 sits on a housing and/or a car body 43.

The locking bracket 44 extends perpendicularly upward from the car body 43. The locking bracket 44 is connected to the car body 43 by means of its lower, fixed end 45. A locking extension protrudes laterally and perpendicularly from the locking bracket 44, and is designed as a locking bolt 46. The locking bolt 46 extends in the tension direction of the tie anchors 40 to 42.

The energy storage module 1 is placed onto the locking bracket 44. In the process, the locking bracket 44 engages through the end plate 30. A locking bracket 44 accordingly is positioned on the opposite side of the energy storage module 1, and engages through the other end plate 35.

The end plate 30 has two recesses designed as through borings 55. The two through borings 55 are located on the upper and lower ends of the end plate 30. The locking bracket 44 extends through these through borings 55.

The locking element, designed as an eccentric 47, is attached on the end plate 30. The eccentric 47 has a clamping surface 48 and is connected in a manner allowing rotation by means of a pivot axle 49 with the end plate 30. The pivot axle 49 extends parallel to the tension direction of the tie anchors 40 to 42. The figure shows the locked state of the energy storage module 1. In this case, the curved clamping surface 48 is located under the locking bolt 46. In addition, a tension spring 52 is arranged. One end of the tension spring 52 is fixed to the end plate 30. The other end of the tension spring 52 engages with the eccentric 47. The tension spring 42 loads the eccentric 47 in such a manner that the clamping surface 48 is pressed against the locking bolt 46. Moreover, a grip 51 is included on the eccentric 47. Before the energy storage module 1 is placed onto the locking bracket 44, the assembler pulls on the grip 51. As a result, the tension spring 52 is placed under load and the clamping surface 48 pivots to the left. As soon as the energy storage module 1 is placed on the locking bracket 44, the assembler lets go of the grip 51 and the tension spring 52 pivots the clamping surface 48 to the right. The clamping between the clamping surface 48 and the locking bolt 46 is realized as a result. In order to prevent an over-extension of the tension spring 52, a limit stop 50 is included on the end plate 30.

FIG. 4 shows a third embodiment of the attachment device 100 according to the invention. Identical and/or functionally identical components are indicated by the same reference numbers in all embodiments. In the third embodiment, the end plate 30 is built with two walls (as is the opposite end plate 35). In FIG. 4, an upper wall 53 of the end plate 30 can be seen. The corresponding lower wall in this case cannot be seen. The lower wall is situated parallel to the upper wall 53 on the inner side. By way of example, the inner wall is designed like the end plate 30 in FIG. 3.

In FIG. 4, a part of the upper wall 53 is drawn as transparent, such that it is possible to see the locking mechanism. A hollow cavity is designed between the upper wall 53 and the lower wall. The locking mechanism is arranged in this hollow cavity. The two through borings 55 particularly lead into this hollow cavity, such that the locking bracket 44 can be inserted through the hollow cavity.

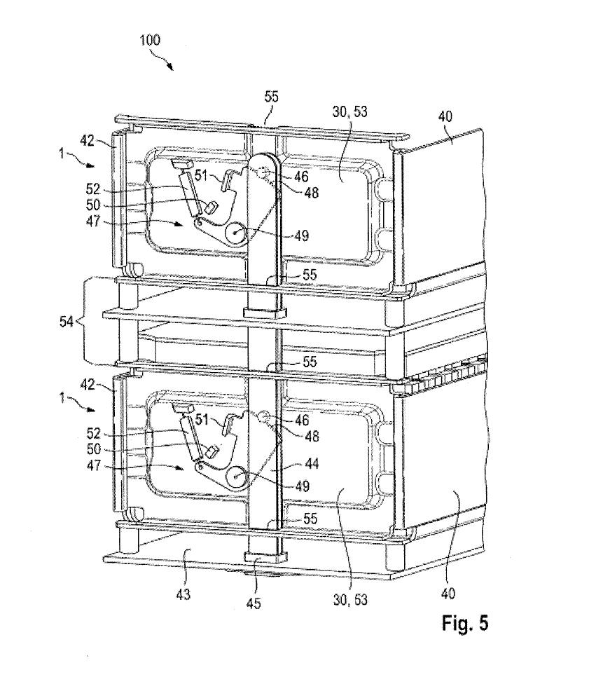

FIG. 5 shows a fourth embodiment of the attachment device 100 according to the invention. Identical and/or functionally identical components are indicated by the same reference numbers in all embodiments. In FIG. 5, two of the energy storage modules 1 having double-walled end plates 30, 35 are arranged over each other on a locking bracket 44. For this purpose, the locking bracket 44 has a longer construction and has two locking bolts 46. An intermediate base 54 is situated between the two energy storage modules 1. The intermediate base 54 also has through borings 55, such that the intermediate base 54 likewise can be placed on the locking brackets 44.

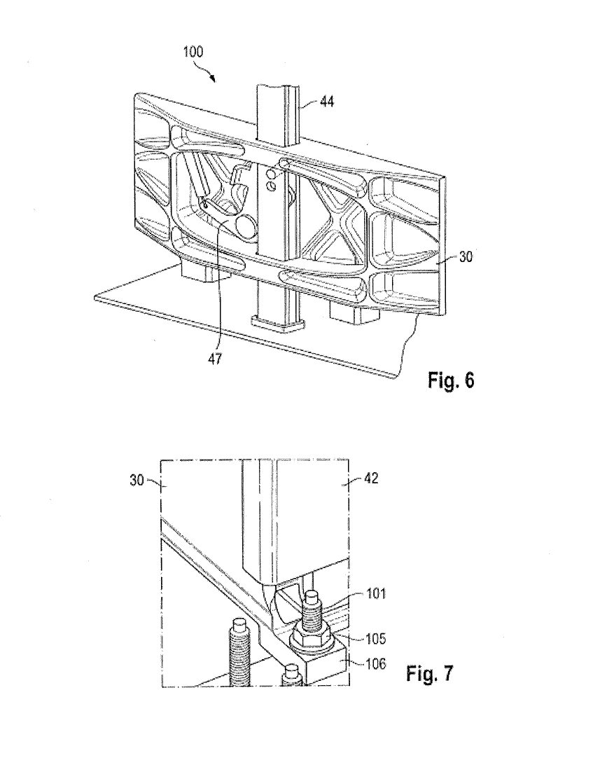

FIG. 6 shows a fifth embodiment of the attachment device 100 according to the invention. Identical and/or functionally identical components are indicated by the same reference numbers in all embodiments. Just as in the first embodiment, in the fifth embodiment as well, the end plate 30 is designed as a cast aluminum part. However, the locking bracket 44 in this case—as in embodiments 2 to 4—has two spaced plates extending longitudinally, parallel and opposite each other. The locking bolt 46 extends between these two plates of the locking bracket 44. As a result, the eccentric 47 also engages between these two longitudinally extended plates.

### LIST OF REFERENCE NUMBERS

1 energy storage module
10 storage cell
11 connection terminal with first polarity
12 connection terminal with second polarity
13 front side
14 rear side
15 primary surface
16 primary surface
20 adhesive film
30 end plate
35 end plate
40 tie anchor
42 tie anchor
43 housing/car body
44 locking bracket
45 fixed end
46 locking extension/locking bolt
47 locking element/eccentric
48 clamping surface
49 pivot axle
50 limit stop
51 grip
52 tension spring
53 upper wall
54 intermediate base
55 recess
100 attachment device
101 bolt
105 threaded connection
106 extension

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. An energy storage module, comprising:
a plurality of storage cells;
at least two end plates; and
at least two tie anchors,
wherein
the plurality of storage cells are aligned between the at least two end plates and the at least two tie anchors to form the energy storage module,
the energy storage module is configured to be placed on and secured on at least one locking bracket, and
at least one of the at least two end plates has a locking element connected to the end plate, the locking element being configured to engage the at least one locking bracket by at least one of a pivoting and a sliding movement.

2. The energy storage module according to claim 1, wherein the locking element has a clamping surface arranged to be at least one of pivoted and slid under a locking extension on the locking bracket.

3. The energy storage module according to claim 1, further comprising:
a spring between the locking element and the end plate, the spring being arranged to support the at least one of the pivoting and the sliding movement of the locking element to engage the at least one locking bracket.

4. The energy storage module according to claim 1, wherein at least one of the at least two end plates has at least one through boring configured to receive the at least one locking bracket.

5. The energy storage module according to claim 1, wherein
at least one of the at least two the end plates comprises two walls, and
the locking element is arranged between the two walls.

6. The energy storage module according to claim 1, wherein the locking element is an eccentric.

7. The energy storage module according to claim 6, wherein the eccentric is connected to the end plate via a pivot axle.

8. An attachment arrangement comprising:
at least one energy storage module according to claim 1; and
the at least one locking bracket on which the energy storage module is placed on and secured.

9. The attachment arrangement according to claim 8, wherein
the at least one locking bracket is fixed on one end thereof to at least one of a housing and a vehicle body,
a clamping surface of the locking element engages underneath a surface of the at least one locking bracket, and
the clamping surface faces a fixed end of the at least one locking bracket.

10. The attachment arrangement according to claim 9, wherein the locking element and the at least one locking bracket are configured to provide a self-locking clamping.

11. The attachment arrangement according to claim 8, wherein the locking bracket is configured to receive a plurality of stacked energy storage modules thereon.
